(19) United States
(12) Patent Application Publication
(10) Pub. No.: US 2025/0033969 A1
(43) Pub. Date: Jan. 30, 2025

(54) METHOD FOR PREPARING SULFIDE ELECTROLYTE THROUGH MULTI-STEP SINTERING, AND SULFIDE ELECTROLYTE PREPARED THEREBY

(71) Applicant: NINGBO INSTITUTE OF MATERIALS TECHNOLOGY AND ENGINEERING, CHINESE ACADEMY OF SCIENCES, Ningbo, Zhejiang (CN)

(72) Inventors: Xiayin Yao, Ningbo, Zhejiang (CN); Gaozhan Liu, Ningbo, Zhejiang (CN); Jing Yang, Ningbo, Zhejiang (CN)

(21) Appl. No.: 18/283,481

(22) PCT Filed: May 31, 2023
(86) PCT No.: PCT/CN2023/097286

§ 371 Date: Sep. 22, 2023

(30) Foreign Application Priority Data
Feb. 10, 2023 (CN) 202310094259.6

(51) Int. Cl. C01B 25/14; C01B 17/22; H01M 10/0562

(52) U.S. Cl. CPC C01B 25/14; C01B 17/22; H01M 10/0562; C01P 2002/72; C01P 2006/40; H01M 2300/008

(57) ABSTRACT

A method for preparing a sulfide electrolyte through multi-step sintering, comprising: performing microwave plasma sintering on a precursor material, and then performing annealing sintering on the precursor material in a muffle furnace to obtain a sulfide electrolyte. By adopting the multi-step sintering method combining microwave plasma sintering and annealing sintering in a muffle furnace, the process of forming crystal nuclei and compacting a preform can be completed quickly, the reaction uniformity of crystal gains in the growing process is guaranteed, and the sulfide electrolyte material with a high crystallinity, a uniform bulk phase and good properties can be obtained rapidly.

### TECHNICAL FIELD

The invention belongs to the technical field of battery electrolytes, and relates to a method for preparing a sulfide electrolyte through multi-step sintering, and a sulfide electrolyte prepared thereby.

### DESCRIPTION OF RELATED ART

Solid electrolytes are an important part of all-solid-state batteries, and sulfide electrolytes have a high room-temperature ionic conductivity and a low electronic conductivity, and also have good mechanical performance, which is beneficial to the formation of good solid-solid contact interfaces between electrodes/electrolytes in all-solid-state batteries.

Most sulfide electrolytes are prepared through solid-phase mixing and annealing sintering, an addition reaction occurs during sintering to generate an electrolyte material, and this process is has three phases: in the first phase, crystal nuclei are formed in grain boundaries or reactant lattices adjacent to the boundaries; in the second phase, the crystal nuclei grow under a high temperature; and in the third phase, a product is thickened, the reaction rate decreases accordingly, and finally, the reaction ends and the electrolyte material is obtained. At present, during the preparation of a sulfide electrolyte, sintering is carried out in a muffle furnace, and due to the limitation of the heating method and the heat conductivity of the electrolyte material, it takes a long time to form the crystal nuclei in the first phase of the sulfide electrolyte sintering process, which is generally 4-48 hrs, thus severely compromising the preparation efficiency of the sulfide electrolyte; moreover, the heating rate of sintering in the muffle furnace is low, which is generally 2-5° C./min, the material undergoes a long time of low-temperature sintering, leading to deformation of pores in the material, which in turn affects the heat conductivity and heat uniformity of the material, making the particle sizes of the material non-uniform.

Microwave plasma sintering can form plasma by ionizing gas with microwaves, and then use the plasma as a heating source to increase the ambient temperature of a preform in the plasma to a high level instantly, such that uniform crystal nuclei can be obtained quickly, the compactness of the preform can be improved, and the first phase of the sintering process can be completed rapidly. However, in the subsequent microwave plasma sintering process of the compact preform, the temperature gradient in the material will be excessively large, resulting in hot spots and thermal runaway in the second half of the sintering process; and some materials will be decrystallized due to over-temperature sintering, compromising the performance of electrolytes.

### BRIEF SUMMARY OF THE INVENTION

In view of the defects in the prior art, the invention provides a method for preparing a sulfide electrolyte through multi-step sintering, and a sulfide electrolyte prepared thereby.

One objective of the invention is fulfilled through the following technical solution:
A method for preparing a sulfide electrolyte through multi-step sintering, comprising: performing microwave plasma sintering on a precursor material, and then performing annealing sintering on the precursor material in a muffle furnace to obtain a sulfide electrolyte.

In the invention, by adopting the multi-step sintering method combining microwave plasma sintering and annealing sintering in a muffle furnace, the process of forming crystal nuclei and compacting a preform can be completed quickly, the reaction uniformity of crystal gains in the growing process is guaranteed, and the sulfide electrolyte material with a high crystallinity, a uniform bulk phase and good properties can be obtained rapidly.

Preferably, the precursor material is prepared by: weighing raw materials including lithium sulfide according to a molar ratio, and then fully mixing the raw materials to obtain the precursor material.

Preferably, a method for preparing the lithium sulfide comprises one or more of a ball-milling method, a carbothermic method, lithiation of a sulfur-containing chemical substance, sulfuration of lithium nano-particles, or inter-reaction between lithium-containing and sulfur-containing substances.

Preferably, a mixing method adopted during the preparation process of the precursor material comprises one or more of mechanical stirring, mechanical oscillation, ball-milling, and roller-milling.

Preferably, during the preparation process of the precursor material, the mixing time is 0.2-1 h.

Preferably, the total sintering time of the microwave plasma sintering and the annealing sintering in the muffle furnace is less than or equal to 1.5 hrs.

Preferably, a heating rate of the microwave plasma sintering is 50-200° C. per minute, the sintering is carried out at a temperature of 80-600° C. for 2-20 min, preferably for 5-15 min. Preferably, a discharge gas for the microwave plasma sintering is nitrogen or argon.

Preferably, after the precursor material undergoes the microwave plasma sintering, a product is directly placed in the muffle furnace for the annealing sintering. After the precursor material undergoes the microwave plasma sintering, the product is directly sintered in the muffle furnace with a set sintering temperature without being cooled.

Preferably, the annealing sintering in the muffle furnace is carried out at a temperature of 180-700° C. for 0.5-1.5 hrs, preferably for 0.5-1.2 hrs. An atmosphere for the annealing sintering in the muffle furnace is an inert atmosphere.

The other objective of the invention is to provide a sulfide electrolyte, which is prepared by the method for preparing a sulfide electrolyte through multi-step sintering.

Preferably, the sulfide electrolyte has one or more of chemical formula I, formula II and formula III:

$$( 100 - x - y ) {Li}_{2} S \cdot {x P}_{2} {S}_{5} \cdot {yM}_{m} {N}_{n} , \qquad formula I$$

Where, 0≤x<100, 0≤y<100, 0≤x+y<100, 0≤m<4, 0≤n<6, M is one or more of Ge, Si, Sn and Sb, and N is one or more of Se, O, Cl, Br and I;

$${Li}_{10 \pm 1} {Ge}_{1 - g} {G}_{g} {P}_{2 - q} {Q}_{q} {S}_{12 - w} {W}_{w} , \qquad formula II$$

Where, 0≤l<1, 0≤g≤1, 0≤q≤2, 0≤w<1, G is Si and/or Sn, Q is Sb, and W is one or more of O, Se, Cl, Br and I;

$${Li}_{6 \pm 1} {P}_{1 - e} {E}_{e} {S}_{5 - s} {R}_{r} {X}_{1 \pm t} , \qquad formula III$$

Where, 0≤l<1, 0≤e<1, 0≤s<2, 0≤r<1, 0≤t<1, E is one or more of Ge, Si, Sn

and Sb, R is O and/or Se, and X is one or more of Cl, Br and I.

Preferably, in formula I, 0<x+y<100.

Preferably, the room-temperature ionic conductivity of the sulfide electrolyte is 1×10⁻⁴-1×10⁻¹ S/cm.

Preferably, the sulfide electrolyte is a crystal.

Compared with the prior art, the invention has the following beneficial effects:
1. The multi-step sintering method combining microwave plasma sintering and annealing sintering in a muffle furnace can complete the process of forming crystal nuclei and compacting a preform quickly, thus greatly shortening the sintering time of materials and improving the production efficiency;
2. The multi-step sintering method combining microwave plasma sintering and annealing sintering in a muffle furnace can guarantee the reaction uniformity of crystal gains in the growing process and obtain a sulfide electrolyte material with a high crystallinity, a uniform bulk phase and good properties rapidly;
3. Compared with sulfide electrolyte materials prepared merely through microwave plasma sintering or annealing sintering in a muffle, the furnace sulfide electrolyte material prepared through the multi-step sintering method combining microwave plasma sintering and annealing sintering in a muffle furnace has better electrolyte properties;
4. In the invention, the time of microwave plasma sintering is controlled to be 2-20 min, the time of annealing sintering in a muffle furnace is controlled to be 0.5-1.5 hrs, and the suitable sintering time is more beneficial for improving the crystallinity and properties of the electrolyte material.

### BRIEF DESCRIPTION OF THE SEVERAL VIEWS OF THE DRAWINGS

FIG. 1 illustrates X-ray diffraction spectrograms of the Li₆PS₅Cl sulfide electrolytes in Embodiment 1, Comparative Example 1 and Comparative Example 2;

FIG. 2 illustrates test charts of the room-temperature ionic conductivity of the Li₆PS₅Cl sulfide electrolytes in Embodiment 1, Comparative Example 1 and Comparative Example 2.

### DETAILED DESCRIPTION OF THE INVENTION

The technical solutions of the invention will be further described below in conjunction with specific embodiments and accompanying drawings. It should be understood that the specific embodiments in the following description are merely used to help understand the invention, and are not intended to limit the invention. Unless otherwise specifically stated, raw materials used in the embodiments of the invention are all common raw materials in the art, and the methods used in the embodiments are all conventional methods in the art.

In the following embodiments and comparative examples, the room-temperature ionic conductivity is tested as follows:

The ionic conductivity of bulk materials was tested in an AC impedance mode using the 1470E electrochemical workstation of UK Solartron Corporation, under the frequency of 10⁶-10⁻² Hz and the amplitude of 15 mV.

Before the AC impedance test, samples were pretreated, the thickness t of the solid electrolyte samples and the room-temperature resistance R of the solid electrolyte samples were measured, and the room-temperature ionic conductivity of the samples was calculated by a formula: σ=t/(R·S), where σ is the conductivity (unit: S/cm), t is the thickness of the tested samples (unit: cm), R is the resistance (unit: Ω), and S is the area of the tested samples (unit: cm²).

In the following embodiments and comparative examples, during the microwave plasma sintering process, the microwave power was 2 kW, and the frequency was 2.45 GHz.

### Embodiment 1

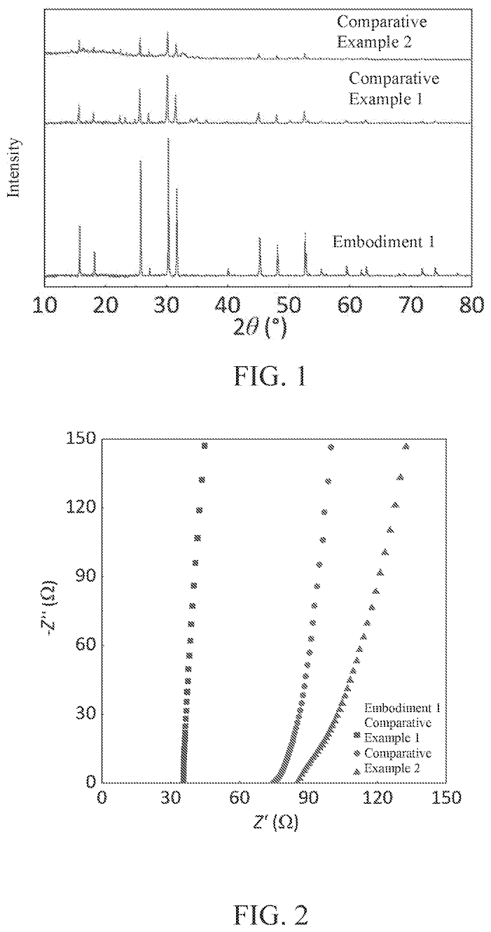

Dry sulfur powder and lithium hydride powder were mixed according to a ratio of amount of substance of 1:2, and then added into a ball-milling tank to be ball-milled at room temperature and a speed of 100 r/min for 24 hrs to obtain lithium sulfide powder; lithium sulfide, phosphorus pentasulfide and lithium chloride were weighed according to a molar ratio, and mechanically stirred at a speed of 200r/min for 20 min to obtain a precursor material; and the precursor material was subjected to microwave plasma sintering in an argon atmosphere at 500° C. for 5 min (the heating rate was 100° C./min), and then a product obtained after the microwave plasma sintering was directly transferred into a muffle furnace at a temperature of 550° C. to be sintered in an argon atmosphere for 1 h to obtain a Li₆PS₅Cl electrolyte. The Li₆PS₅Cl electrolyte had a high crystallinity. An X-ray diffraction spectrogram of the Li₆PS₅Cl electrolyte is shown in FIG. 1. The room-temperature ionic conductivity of the Li₆PS₅Cl electrolyte was 3.6 mS/cm. Test results are shown in FIG. 2.

### Embodiment 2

Li₂S was prepared by inter-reaction between lithium-containing and sulfur-containing compounds: lithium and elemental sulfur were dissolved in an organic solvent (diethyl ether) respectively according to a ratio of amount of substance of 2.1:1, mixed, and then distillated under reduced pressure to obtain Li₂S; lithium sulfide, germanium disulfide and phosphorus pentasulfide are weighed according to a molar ratio, and mechanically stirred at a speed of 300 r/min for 15 min to obtain a precursor material; and the precursor material was subjected to microwave plasma sintering in a nitrogen atmosphere at 550° C. for 10 min (the heating rate was 100° C./min), and then a product obtained after the microwave plasma sintering was directly transferred into a muffle furnace at a temperature of 620° C. to be sintered in a nitrogen atmosphere for 1 h to obtain a Li₁₀GeP₂S₁₂ electrolyte. The Li₁₀GeP₂S₁₂ electrolyte had a high crystallinity, and the room-temperature ionic conductivity of the Li₁₀GeP₂S₁₂ electrolyte was 6.3 mS/cm.

### Embodiment 3

Li₂S was prepared by a carbothermic method: anhydrous lithium sulfate, glucose and hard carbon were mixed according to a mass ratio of 1:2:5, and then heated to 900° C. in a hydrogen atmosphere to react to obtain Li₂S; lithium sulfide and phosphorus pentasulfide were weighed according to a molar ratio, and ball-milled at a speed of 500 r/min for 1 h to obtain a precursor material; and the precursor material was subjected to microwave plasma sintering in a nitrogen atmosphere at 150° C. for 5 min (the heating rate was 100° C./min), and then a product obtained after the microwave plasma sintering was directly transferred into a muffle furnace at a temperature of 230° C. to be sintered in a nitrogen atmosphere for 0.5 h to obtain a Li₃PS₄ electrolyte. The Li₃PS₄ electrolyte had a high crystallinity, and the room-temperature ionic conductivity of the Li₃PS₄ electrolyte was 0.4 mS/cm.

### Embodiment 4

Li₂S was prepared by a ball-milling method and inter-reaction between lithium-containing and sulfur-containing compounds: lithium and elemental sulfur were dissolved in an organic solvent (tetrahydrofuran) respectively according to a ratio of amount of substance of 2.2:1, ball-milled and mixed at 200r/min for 24 hrs, and then distillated under reduced pressure to obtain Li₂S; lithium sulfide, phosphorus pentasulfide and lithium iodide were weighed according to a molar ratio, mechanically stirred at a speed of 100 r/min for 10 min, and then ball-milled at 500 r/min for 30 min to obtain a precursor material; and the precursor material was subjected to microwave plasma sintering in an argon atmosphere at 100° C. for 5 min (the heating rate was 100° C./min), and then a product obtained after the microwave plasma sintering was directly transferred into a muffle furnace at a temperature of 200° C. to be sintered in an argon atmosphere for 0.6 h to obtain a Li₇P₂S₈I electrolyte. The Li₇P₂S₈I electrolyte had a high crystallinity, and the room-temperature ionic conductivity of the Li₇P₂S₈I electrolyte was 1.2 mS/cm.

### Embodiment 5

Li₂S was prepared by a ball-milling method: dry sulfur powder and lithium hydride powder were mixed according to a ratio of amount of substance of 1:2, and then added into a ball-milling tank to be ball-milled at room temperature under 500 r/min for 12 hrs to obtain Li₂S; lithium sulfide, phosphorus pentasulfide and lithium chloride were weighed according to a molar ratio, and roller-milled at a speed of 300 r/min for 1 h to obtain a precursor material; and the precursor material was subjected to microwave plasma sintering in a nitrogen atmosphere at 490° C. for 6 min (the heating rate was 100° C./min), and then a product obtained after the microwave plasma sintering was directly transferred into a muffle furnace at a temperature of 550° C. to be sintered in a nitrogen atmosphere for 1 h to obtain a Li_{5.4}PS_{4.4}Cl_{1.6} electrolyte. The Li_{5.4}PS_{4.4}Cl_{1.6} electrolyte had a high crystallinity, and the room-temperature ionic conductivity of the Li_{5.4}PS_{4.4}Cl_{1.6} electrolyte was 8.2 mS/cm.

### Embodiment 6

Li₂S was prepared by a ball-milling method: dry sulfur powder and lithium hydride powder were mixed according to a ratio of amount of substance of 1:2.5, and then added into a ball-milling tank to be ball-milled at room temperature under 300 r/min for 24 hrs to obtain Li₂S; lithium sulfide and phosphorus pentasulfide were weighed according to a molar ratio, mechanically stirred at a speed of 200 r/min for 10 min, and then subjected to high-energy ball-milling at 500 r/min for 30 min to obtain a precursor material; and the precursor material was subjected to microwave plasma sintering in an argon atmosphere at 120° C. for 5 min (the heating rate was 100° C./min), and then a product obtained after the microwave plasma sintering was directly transferred into a muffle furnace at a temperature of 260° C. to be sintered in an argon atmosphere for 0.5 h to obtain a Li₇P₃S₁₁ electrolyte. The Li₇P₃S₁₁ electrolyte had a high crystallinity, and the room-temperature ionic conductivity of the Li₇P₃S₁₁ electrolyte was 1.2 mS/cm.

### Embodiment 7

Li₂S was prepared by a ball-milling method and inter-reaction between lithium-containing and sulfur-containing substances: lithium and elemental sulfur were dissolved in tetrahydrofuran respectively according to a ratio of amount of substance of 2.2:1, ball-milled and mixed at 200r/min for 24 hrs, and then distillated under reduced pressure to obtain Li₂S; lithium sulfide, phosphorus pentasulfide, lithium chloride and phosphorus pentoxide were weighed according to a molar ratio, and then mechanically oscillated at a speed of 200 r/min for 30 min to obtain a precursor material; and the precursor material was subjected to microwave plasma sintering in an argon atmosphere at 520° C. for 7 min (the heating rate was 100° C./min), and then a product obtained after the microwave plasma sintering was directly transferred into a muffle furnace at a temperature of 570° C. to be sintered in an argon atmosphere for 1 h to obtain a Li₆PS_{4.8}O_{0.2}Cl electrolyte. The Li₆PS_{4.8}O_{0.2}Cl electrolyte had a high crystallinity, and the room-temperature ionic conductivity of the Li₆PS_{4.8}O_{0.2}Cl electrolyte was 15.2 mS/cm.

### Embodiment 8

Li₂S was prepared by a ball-milling method: dry sulfur powder and lithium hydride powder were mixed according to a ratio of amount of substance of 1:2, and then added into a ball-milling tank to be ball-milled at room temperature under 100 r/min for 24 hrs to obtain Li₂S; lithium sulfide, phosphorus pentasulfide, lithium chloride and lithium bromide were weighed according to a molar ratio and then mechanically stirred at a speed of 200 r/min for 30 min to obtain a precursor material; and the precursor material was subjected to microwave plasma sintering in an argon atmosphere at 480° C. for 8 min (the heating rate was 100° C./min), and then a product obtained after the microwave plasma sintering was directly transferred into a muffle furnace at a temperature of 530° C. to be sintered in an argon atmosphere for 0.8 h to obtain a Li₆PS₅Cl_{0.5}Br_{0.5} electrolyte. The Li₆PS₅Cl_{0.5}Br_{0.5} electrolyte had a high crystallinity, and the room-temperature ionic conductivity of the Li₆PS₅Cl_{0.5}Br_{0.5} electrolyte was 10.2 mS/cm.

### Embodiment 9

Li₂S was prepared by sulfurating lithium nano-particles: the lithium nano-particles were dispersed in a tetrahydrofuran-n-hexane medium, and a mixture of hydrogen sulfide and argon was introduced to react with the lithium nano-particles for 24 hrs to obtain Li₂S; lithium sulfide, phosphorus pentasulfide, lithium chloride and phosphorus pentoxide are weighed according to a molar ratio, mechanically stirred at a speed of 300 r/min for 10 min, and then ball-milled at 400 r/min for 30 min to obtain a precursor material; and the precursor material was subjected to microwave plasma sintering in an argon atmosphere at 480° C. for 9 min (the heating rate was 100° C./min), and then a product obtained after the microwave plasma sintering was directly transferred into a muffle furnace at a temperature of 560° C. to be sintered in an argon atmosphere for 0.9 h to obtain a Li_{5.4}PS_{4.2}O_{0.2}Cl_{1.6} electrolyte. The Li_{5.4}PS_{4.2}O_{0.2}Cl_{1.6} electrolyte had a high crystallinity, and the room-temperature ionic conductivity of the Li_{5.4}PS_{4.2}O_{0.2}Cl_{1.6} electrolyte was 12 mS/cm.

### Embodiment 10

Li₂S was prepared by inter-reaction between lithium-containing and sulfur-containing substances: lithium and elemental sulfur were dissolved in methylbenzene respectively according to a ratio of amount of substance of 2.1:1, mixed, and then distillated under reduced pressure to obtain Li₂S; lithium sulfide, phosphorus pentasulfide, germanium disulfide and lithium iodide were weighed according to a molar ratio, mechanically stirred at a speed of 200 r/min for 10 min, and then ball-milled at 400 r/min for 40 min to obtain a precursor material; and the precursor material was subjected to microwave plasma sintering in an argon atmosphere at 400° C. for 8 min (the heating rate was 100° C./min), and then a product obtained after the microwave plasma sintering was directly transferred into a muffle furnace at a temperature of 540° C. to be sintered in an argon atmosphere for 1 h to obtain a Li_{6.6}P_{0.4}Ge_{0.6}S₈I electrolyte. The Li_{6.6}P_{0.4}Ge_{0.6}S₈I electrolyte had a high crystallinity, and the room-temperature ionic conductivity of the Li_{6.6}P_{0.4}Ge_{0.6}S₈I electrolyte was 18 mS/cm.

### Comparative Example 1

The chemical formula of a sulfide electrolyte in this comparative example is Li₆PS₅Cl. The preparation method of the Li₆PS₅Cl electrolyte in this comparative example differs from the preparation method of the electrolyte in Embodiment 1 in that the precursor material did not undergo the microwave plasma sintering process, and was directly sintered in a muffle furnace at 550° C. for 1 h, and an obtained product contained a large quantity of intermediate phases and had a low crystallinity, indicating that the sintering reaction was incomplete. An X-ray diffraction spectrogram of the Li₆PS₅Cl electrolyte in this comparative example is shown in FIG. 1. The room-temperature ionic conductivity of the Li₆PS₅Cl electrolyte was 1.7 mS/cm, and the impedance of the grain boundary was large. Test results are shown in FIG. 2.

### Comparative Example 2

The chemical formula of a sulfide electrolyte in this comparative example is Li₆PS₅Cl. The preparation method of the Li₆PS₅Cl electrolyte in this comparative example differs from the preparation method of the electrolyte in Embodiment 1 in that the precursor material was not sintered in a muffle furnace, and was only subjected to microwave plasma sintering at 500° C. for 1 h, and an obtained product had a low crystallinity and contained a large quantity of impurity phases. An X-ray diffraction spectrogram of the Li₆PS₅Cl electrolyte in this comparative example is shown in FIG. 1. The room-temperature ionic conductivity of the Li₆PS₅Cl electrolyte was 1.5 mS/cm, and the impedance of the grain boundary was large. Test results are shown in FIG. 2.

### Comparative Example 3

The chemical formula of a sulfide electrolyte in this comparative example is Li₆PS₅Cl. The preparation method of the Li₆PS₅Cl electrolyte in this comparative example differs from the preparation method of the electrolyte in Embodiment 1 in that the precursor material did not undergo the microwave plasma sintering process, and was directly sintered in a muffle furnace at 550° C. for 4 hrs, and the sintering reaction was complete. The room-temperature ionic conductivity of the Li₆PS₅Cl electrolyte prepared through sintering in the muffle furnace was 3.0 mS/cm.

### Comparative Example 4

The chemical formula of a sulfide electrolyte in this comparative example is Li₆PS₅Cl. The preparation method of the Li₆PS₅Cl electrolyte in this comparative example differs from the preparation method of the electrolyte in Embodiment 1 in that the precursor material was not sintered in a muffle furnace, and was only subjected to microwave plasma sintering at 500° C. for 5 min, and an obtained product contained a large quantity of intermediate phases, indicating that the sintering reaction was incomplete. The room-temperature ionic conductivity of the Li₆PS₅Cl electrolyte was 0.9 mS/cm.

### Comparative Example 5

The chemical formula of a sulfide electrolyte in this comparative example is Li₆PS₅Cl. The preparation method of the Li₆PS₅Cl electrolyte in this comparative example differs from the preparation method of the electrolyte in Embodiment 1 in that the precursor material was not sintered in a muffle furnace, and was only subjected to microwave plasma sintering at 500° C. for 30 min, and the sintering reaction was complete. The room-temperature ionic conductivity of the Li₆PS₅Cl electrolyte was 2.4 mS/cm.

All aspects, embodiments and features of the invention should be regarded as illustrative in every respect, and are not used to limit the invention. The scope of the invention is defined merely by the claims. Those skilled in the art will be able to appreciate other embodiments, modifications and uses, without deviating from the spirit and scope of the invention.

The execution order of the steps of the preparation method in the invention is not limited to those listed here, and changes to the execution order of these steps made by those ordinarily skilled in the art without creative labor should also fall within the protection scope of the invention. In addition, two or more of these steps or actions may be performed at the same time.

Finally, it should be noted that the specific embodiments described in this specification are merely used to describing the spirit of the invention by way of examples, and are not intended to limit the embodiments of the invention. Those skilled in the art can make various modifications, supplements or similar substitutions to the specific embodiments described here, and it is unnecessary and impossible to exhaust all possible embodiments of the invention. All obvious changes or transformations derived based on the essential spirit of the invention should fall within the protection scope of the invention, and it is against the spirit of the invention to interpret these changes or transformations as any additional limitations.

What is claimed is:

1. A method for preparing a sulfide electrolyte through multi-step sintering, comprising: performing microwave plasma sintering on a precursor material, and then performing annealing sintering on the precursor material in a muffle furnace to obtain a sulfide electrolyte.

2. The method for preparing a sulfide electrolyte through multi-step sintering according to claim 1, wherein the precursor material is prepared by: weighing raw materials comprising lithium sulfide according to a molar ratio, and then fully mixing the raw materials to obtain the precursor material.

3. The method for preparing a sulfide electrolyte through multi-step sintering according to claim 2, wherein a method for preparing the lithium sulfide comprises one or more of a ball-milling method, a carbothermic method, lithiation of a sulfur-containing chemical substance, sulfuration of lithium nano-particles, or inter-reaction between lithium-containing and sulfur-containing substances;
and/or, a mixing method adopted during the preparation process of the precursor material comprises one or more of mechanical stirring, mechanical oscillation, ball-milling, and roller-milling, and a mixing time is 0.2-1 h.

4. The method for preparing a sulfide electrolyte through multi-step sintering according to claim 1, wherein a total sintering time of the microwave plasma sintering and the annealing sintering in the muffle furnace is less than or equal to 1.5 hrs.

5. The method for preparing a sulfide electrolyte through multi-step sintering according to claim 1, wherein the microwave plasma sintering is carried out at a temperature of 80-600° C. for 2-20 min.

6. The method for preparing a sulfide electrolyte through multi-step sintering according to claim 1, wherein after the precursor material undergoes the microwave plasma sintering, a product is directly placed in the muffle furnace for the annealing sintering, and the annealing sintering in the muffle furnace is carried out at a temperature of 180-700° C. for 0.5-1.5 hrs.

7. A sulfide electrolyte, being prepared by the method for preparing a sulfide electrolyte through multi-step sintering according to claim 1.

8. The sulfide electrolyte according to claim 7, having one or more of chemical formula I, formula II and formula III:
$$( 100 - x - y ) {Li}_{2} S \cdot {x P}_{2} {S}_{5} \cdot {yM}_{m} {N}_{n} , \qquad formula I$$
where, 0≤x<100, 0≤y<100, 0≤x+y<100, 0≤m<4, 0≤n<6, M is one or more of Ge, Si, Sn and Sb, and N is one or more of Se, O, Cl, Br and I;
$${Li}_{10 \pm 1} {Ge}_{1 - g} {G}_{g} {P}_{2 - q} {Q}_{q} {S}_{12 - w} {W}_{w} \qquad formula II$$
where, 0≤l<1, 0≤g≤1, 0≤q≤2, 0≤w<1, G is Si and/or Sn, Q is Sb, and W is one or more of O, Se, Cl, Br and I;
$${Li}_{6 \pm 1} {P}_{1 - e} {E}_{e} {S}_{5 - s} {R}_{r} {X}_{1 \pm t} , \qquad formula III$$
where, 0≤l<1, 0≤e<1, 0≤s<2, 0≤r<1, 0≤t<1, E is one or more of Ge, Si, Sn and Sb, R is O and/or Se, and X is one or more of Cl, Br and I.

9. The sulfide electrolyte according to claim 7, wherein a room-temperature ionic conductivity of the sulfide electrolyte is 1×10⁻⁴-1×10⁻¹ S/cm.

10. The sulfide electrolyte according to claim 7, wherein the sulfide electrolyte is a crystal.
